(19) United States
(12) Patent Application Publication
(10) Pub. No.: US 2026/0257231 A1
(43) Pub. Date: Sep. 3, 2026

(54) CENTRIFUGAL SEPARATOR, IN PARTICULAR STERILIZATION SEPARATOR, AND METHOD FOR STERILIZING MILK

(71) Applicant: GEA WESTFALIA SEPARATOR GROUP GMBH, Oelde (DE)

(72) Inventors: Michael MEYER, Beckum (DE); Dirk ESSELING, Oelde (DE)

(21) Appl. No.: 19/489,964

(22) PCT Filed: May 14, 2024
(86) PCT No.: PCT/EP2024/063270

§ 371 Date: Dec. 4, 2025

(30) Foreign Application Priority Data
Jun. 5, 2023 (DE) 10 2023 114 725.0

(51) Int. Cl. B04B 11/02; A23C 7/04; B04B 1/08

(52) U.S. Cl. CPC B04B 11/02; A23C 7/046; B04B 1/08; A23C 2210/256

(57) ABSTRACT

A bacteria-removing separator separate a product into a solid phase, a first lighter liquid phase, and a second heavier liquid phase. The separator has a distributor arranged in the centrifugal drum for feeding a product from a product feed tube into the separating chamber. The distributor has first openings conducting a first part of the product fed by the distributor from the distributor channels into the disc pack. The distributor includes one or more second openings introducing a second part of the product outwardly into the centrifugal drum.

### BACKGROUND AND SUMMARY OF THE INVENTION

Exemplary embodiments of the present invention relate to a centrifugal separator, in particular a sterilization separator, according and a method for sterilizing milk.

Centrifugal separators are used for a wide variety of separation and/or clarification tasks, such as the sterilization of milk. These centrifugal separators are also called sterilization separators. The classic application of a sterilization separator is the clarification of milk—which forms the lighter liquid phase—from bacteria and spores—the so-called germ flora—which form the heavy liquid phase. This heavy liquid phase may also contain impurities such as udder cells. During sterilization, it may provided that a continuous feed milk into the centrifugal drum and a continuous centrifugal separation and clarification of the milk fed into the centrifugal drum is carried out. In this process, the milk is separated into a solid phase, which contains germs and spores, a first lighter liquid phase consisting of sterilized milk, and a second heavier liquid phase, wherein the second heavier liquid phase is formed from a flowable concentrate containing, among other things, germs and proteins. However, this sterilization process does not, or essentially does not, separate the cream from the skimmed milk.

Such a sterilization separator is known from the generic DE 38 02 305 C1. It has a rotating centrifugal drum in which a separating disc pack is arranged. The milk to be sterilized is fed through a stationary inlet pipe into a distributor of the centrifugal separator, which rotates with the centrifugal drum during operation, where it is accelerated to the centrifugal drum speed in the distributor channels. The distributor channels have openings through which the milk can flow into the rising channels of the separating disc pack. A sludge consisting of bacteria and germs is separated from the milk as a solid phase in the centrifugal field and collected in a solids collecting chamber located radially outside the centrifugal drum, from which it is discharged discontinuously through solids discharge openings. The clarified milk flows through the separating disc pack into the radial center of the centrifuge drum and is directed from there into a gripper chamber, from which it is discharged by means of a first centripetal pump. In a radial area or space between the separating disc pack and the separated germs (=solid phase), a still flowable protein and germ concentrate accumulates, which contains, among other things, germs and proteins, which is led out of the separating chamber through channels above a separating disc above the separating disc stack by means of a further centripetal pump. This flowable concentrate is recirculated into the inlet. This is to ensure that even “lighter” bacteria and spores are reliably separated in a further “separation run”.

Effective sterilization is achieved when the centrifugal drum of the centrifugal separator provides the largest possible clarification area suitable for the corresponding feed rate. The clarification area load should be at least 0.1 l/h per m² (feed rate/equivalent clarification area).

If the feed rate is set too low or, in other words, if the clarification area is too large, this can lead to excessive separation of protein from the milk. If the milk protein content (milk protein content) in the heavier liquid phase (concentrate) is too high, this phase may even thicken in the solids collecting chamber of the centrifugal drum, so that it can no longer be discharged from the centrifugal drum as a flowable liquid phase via a separating disc. This also hinders the separation of bacteria in the solids collecting chamber, as the solid protein layer that builds up prevents the flow into the solids collecting chamber of the centrifugal separator.

The incoming cow's milk typically has a protein content of approx. 3.5 wt/vol % (see, for example, EP 1 768 493 B1, [0030]).

The effect of thickening of the heavier liquid phase described above, with the resulting disadvantages, appears to be particularly problematic. Based on the prior art, exemplary embodiments of the invention are directed to reducing this effect.

A centrifugal separator is created which is designed in particular as a sterilization separator for the sterilization of milk and is intended to separate a flowable product to be processed into a solid phase (sludge with germs) and into a first liquid phase and a second liquid phase in a centrifugal field and which has at least the following: a rotatable centrifugal drum with a vertical axis of rotation, a separating disc pack formed in a separating chamber of the centrifugal drum, a distributor arranged in the centrifugal drum for feeding the product from a product feed pipe into the separating chamber, wherein the product is fed into the separating chamber during operation in the distributor (note: in this way, the product is accelerated to the centrifugal drum speed in distribution channels of the distributor), wherein the distributor further comprises first openings, so that a first portion of the product P fed through the distributor is fed from the distribution channels into the disc pack, preferably into rising channels of the separating disc pack, wherein the separating chamber has a radially outer solids collecting chamber and discontinuously closable solids discharge openings for discharging the solids phase S, as well as a first liquid discharge for discharging the lighter liquid phase and a second liquid discharge for discharging the heavier liquid phase. It is also provided that, in addition to the first openings in the distributor, one or more second openings are formed which introduce a second portion of the product P into the centrifugal drum in an outward direction.

This dilutes the heavier liquid phase in the separating chamber, thus easily preventing clogging of flow paths in the drum. In the case of milk sterilization, the heavier liquid phase is a still-flowable concentrate that contains a higher proportion of proteins and germs than the product, in this case milk.

It may be optionally advantageously provided that the first openings and/or the second openings are provided in a distributor base and are provided, at least in part, with replaceable sleeves. In this way, the cross-section of the respective openings can be easily changed and adapted to the respective product properties by inserting sleeves with a respective optimized passage cross-section.

It may then be further particularly preferably provided that a first part of the discharged second heavier liquid phase can be recycled into the centrifugal drum and that a second part of the second liquid phase is drainable.

The invention also provides a method for sterilizing milk with a sterilization separator characterized by the following steps of:
i) providing the sterilization separator,
ii) rotating the centrifugal drum,
iii) continuous centrifugal separation of milk fed into the centrifugal drum in the centrifugal drum, wherein the milk is separated into a solid phase S, consisting in particular of germs and spores, and a first lighter liquid phase L1 consisting of sterilized milk and a second heavier liquid phase L2, wherein the second liquid phase is formed from a flowable protein and germ concentrate containing, among other things, germs and proteins, and
iv) recirculating a first part of the second liquid phase into the centrifugal drum and discharging a second part of the second liquid phase from the sterilization separator, wherein, when the milk to be processed is fed in, a first part thereof is fed through first openings in the distributor into the separating disc pack, and wherein a further portion of the milk to be processed is fed through one or more second openings into a region radially outside the separating disc pack.

In this method, too, the heavier liquid phase is diluted in the separating chamber and clogging of flow paths in the drum is avoided. The separated portion of the concentrate can be further processed, for example, it can be used for protein-enriched milk drinks, yogurt—optionally after a germ-reducing heat treatment such as sterilization and subsequent cooling—or similar products.

### BRIEF DESCRIPTION OF THE DRAWING FIGURES

The invention is described in more detail below with reference to the drawings, wherein:

FIG. 1: shows a schematic cross-sectional view of a centrifugal separator according to the invention;

FIG. 2: shows an enlarged detail of FIG. 1;

FIG. 3: shows a schematic cross-sectional view of a prior-art centrifugal separator.

### DETAILED DESCRIPTION

The following description of the figure describes an exemplary embodiment. Individual features of this exemplary embodiment can also be combined with exemplary embodiments not shown and are also suitable as advantageous designs of the objects described in one or more of the main and subclaims.

The terms used in the following, such as “top,” “bottom,” “right,” “left,” “horizontal,” or “vertical,” refer to the representation in the respective figure.

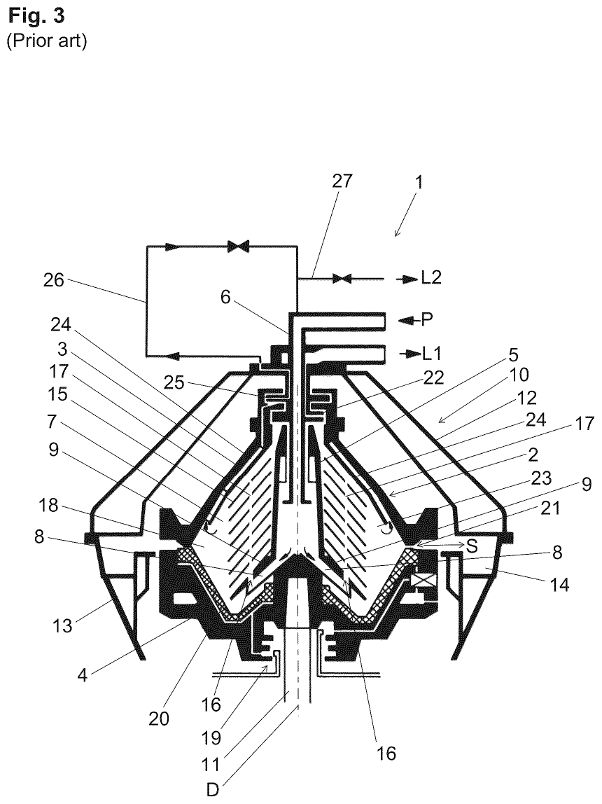

First, the centrifugal separator according to the prior art is described in FIG. 3. The centrifugal separator 1 in FIG. 3 is preferably designed as a self-emptying centrifugal separator, in particular as a sterilization separator.

The centrifugal separator 1 has a centrifugal drum 2 that rotates during operation. The centrifugal drum 2 can have a vertical axis of rotation D. The centrifugal drum 2 is shown here schematically and can be designed with a single and/or double cone (at the bottom and/or top and, in particular, on the inside), as shown here. It is arranged on a drive spindle 11, to which it is coupled in a rotationally fixed manner. During operation, this drive spindle can be rotated by a drive motor (not shown here) and accelerated to an operating speed in order to generate a centrifugal acceleration of several thousand g in the drum.

The centrifugal drum 2 is preferably designed for continuous operation, i.e., for continuous, non-batch centrifugal processing of a flowable suspension, in this case, preferably milk to be sterilized. The centrifugal separator is preferably designed, as shown here, as a sterilization separator, which is intended to separate a product P—in this case raw milk—into a solid phase S—in this case bacteria and germs—and two liquid phases L1 and L2 of different densities—in this case a lighter liquid phase from clarified milk and a flowable, heavier concentrate phase with a high protein content.

The centrifuge drum 2 may comprise a centrifuge drum upper part 3 and a centrifuge drum lower part 4. These centrifuge drum parts 3, 4 may be connected to each other in various ways, for example with a sealing ring (also not shown here).

A product feed pipe 6 protrudes into the centrifugal drum 2. The centrifugal drum 2 also has a distributor 5 rotationally coupled to the centrifugal drum for feeding the product from the product feed pipe 6 into a separating chamber 7. In the distributor 5, the product P is transferred into the rotating system. The product P is accelerated to the speed of the centrifugal drum in distributor channels 8. The distributor channels 8 can be formed in a distributor base 9.

The product feed pipe 6 is fed into the centrifugal separator 1 from above through a hood 10, which is stationary during operation, or from the end of the centrifugal drum 2 opposite the drive spindle 11.

The hood 10 can be arranged on a machine frame (not shown here) and supported by it. The hood 10 can be divided into an upper conical hood part 12 and a lower conical hood part 13. The lower hood part 13 also forms a solids trap 14.

The actual centrifugal separation of the product P into the different phases takes place in the separating chamber 7. The separating chamber 7 has a separating means, preferably a separating disc pack 15 consisting of separating discs. First openings 16 are formed in the distribution channels 8 on the upper side of the distribution base. In a preferred embodiment, these can extend in the axial direction. It is essential that a first portion of the product P fed in and flowing through the distributor—in particular, but not necessarily, milk to be sterilized—is introduced into the disc pack through the first openings 16. In the exemplary embodiment shown, this first portion can be introduced into axially extending rising channels 17 of the separating disc pack 15, which can be formed from aligned bores in the separating discs.

The separating chamber 7 has a solids collecting chamber 18 radially outside the separating disc pack 15, in which the solid phase S separated from the suspension or the flowable product P collects during the separation and/or clarification process.

A discharge system 19 is used to discharge the solid phase S from the solids collecting chamber 18 of the centrifugal drum 2. This can be a fluid-operated design, as shown here. The fluid-operated discharge system 19 may have a piston slide valve 20 for opening and closing a plurality of solids discharge openings 21, which may be distributed circumferentially in the region of the largest diameter of the centrifugal drum 2. The emptying system 19 may also comprise a control fluid system associated with the piston slide valve 20 for controlling its opening and closing movements.

The centrifugal separator 1 then has a first liquid discharge 22 through which the lighter liquid phase L1—i.e., the sterilized or clarified milk that flows through the separating disc pack 15 into the center of the centrifugal drum 2—can be discharged from the centrifugal drum 2. The first liquid outlet 22 can be designed, for example, as a so-called paring disc, which functions as a centripetal pump. Alternatively, the first liquid outlet 22 can also be implemented in another way, e.g., by means of a hermetically designed liquid outlet.

In a radial space 23 between the separating disc pack 15 and the solid phase S, a concentrate phase accumulates as a second, heavier liquid phase L2, which is guided out of the centrifugal drum 2 through channels 24 above the separating disc pack 15 by a second liquid discharge 25. The second liquid discharge 25 is also designed as a paring disc here. The second liquid discharge 25 can also be implemented in other ways, e.g., by means of a hermetically designed liquid discharge.

A first portion of the discharged concentrate is recirculated through a first line 26 into the product feed pipe 6. This ensures that even “lighter” bacteria and spores are more reliably separated during a further “separation cycle”. A second portion of the protein-enriched concentrate can be discharged via a second line 27 and further processed if necessary.

During centrifugal clarification of the milk, the protein content in the concentrate may increase (protein is separated by centrifugal force), which can lead to the thickening of the concentrate described in the introductory description, which in turn can hinder the separation of bacteria and spores.

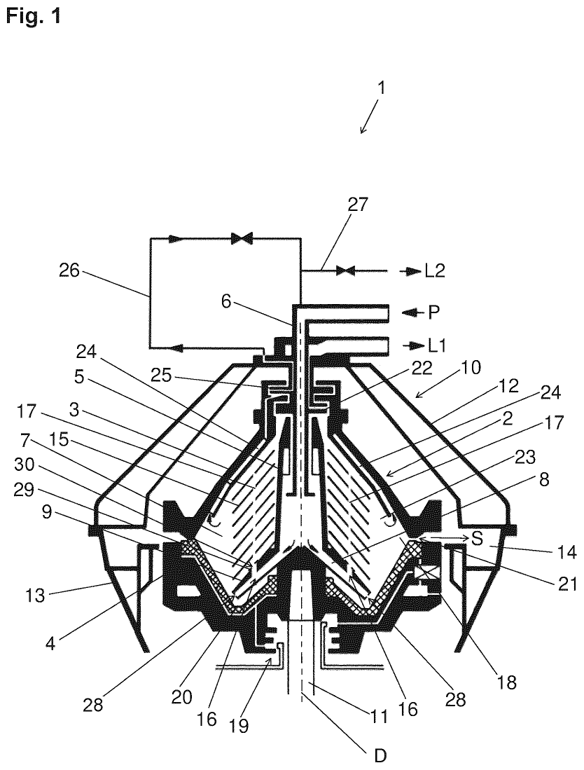

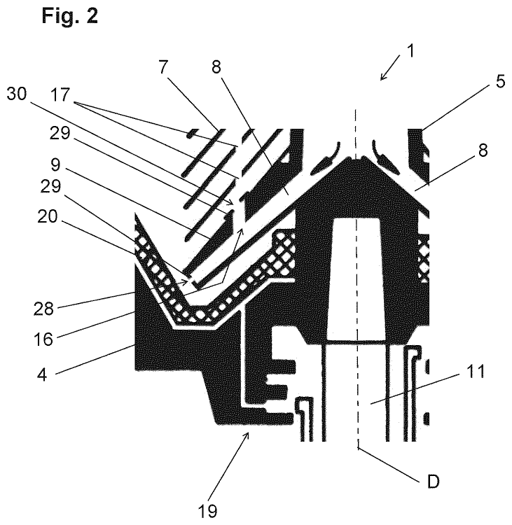

To counteract this effect, unlike in FIG. 3, the exemplary embodiment shown in FIGS. 1 and 2 (modified only to this extent) provides for a special design of the distributor base 9 of the centrifugal separator 1 to prevent thickening of the concentrate due to an excessively high protein content.

This is achieved by providing, in addition to the first openings 16 in the distributor base 9, which direct the product P—i.e., the milk—into the rising channels 17, second openings 28 are also provided on an outer circumference of the distributor base 9, which direct a portion of the product, in particular the milk to be clarified, toward the solids collecting chamber 18 (see FIGS. 1 and 2). According to a preferred exemplary embodiment, these second openings 28 can be aligned in such a way that the remaining part of the product, in particular the milk to be optionally preferably clarified, flows essentially radially into the separating chamber.

This dilutes the protein-enriched heavier liquid phase L2—i.e., the concentrate—in the solids collecting chamber 18, thus preventing blockage of the solids collecting chamber 18 and/or the channels above the separating disc stack.

In order to achieve a targeted distribution of the volume flows of the product to be clarified—i.e., the milk to be clarified—into the rising channels 17 on the one hand and into the solids collection chamber 18 on the other, it may be provided, as an optional further development, that the first openings 16 and/or the second openings 28 of the distributor base 9 are provided with replaceable sleeves 29 with a respective passage cross-section. These are then inserted into the openings and fixed there. For example, they can be clamped there or fixed using a type of thread or similar. To change the sleeves, it may also be provided that the distributor base is separable, so that, for example, a lower part can be removed from it, allowing the sleeves 29 to be changed.

It is not necessary to provide all openings with sleeves in order to change the total passage cross-sections of the first and/or second openings, although this is also conceivable.

The passage cross-section of the first and/or second openings through which the supplied product flows into the separating chamber can thus be varied by providing replaceable sleeves 29 with differently sized passage openings 16, 30 or passage cross-sections.

By suitably selecting the passage cross-section of the passage openings 16, 30 of the sleeves 29, the distribution of the milk flow from the distributor 5 into the rising channels 17 or in the direction of the solids collecting chamber 18 can be carried out individually and in a manner advantageous for the process.

The respective optimum passage cross-sections of the passage openings 16, 30 of the sleeves 29 to the rising channels 17 or in the direction of the solids collecting chamber 18 can be determined, for example, by means of tests.

It should also be noted that the centrifugal separator is assigned an electronic control unit for controlling and regulating the centrifugal processing, with which, for example, the speed of a drive motor not shown here can be regulated and actuators not shown here can be controlled.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Centrifugal separator
2 Centrifugal drum
3 Drum upper part
4 Drum lower part
5 Distributor
6 Product feed pipe
7 Separating chamber
8 Distributor channel
9 Distributor base
10 Hood
11 Drive spindle
12 Hood part
13 Hood part
14 Solids trap
15 Separating disc pack
16 First opening
17 Rising channel
18 Solids collecting chamber
19 Discharge system
20 Piston slide valve
21 Solids discharge opening
22 First liquid discharge
23 Chamber
24 Channel
25 Second liquid discharge
26 First line
27 Second line
28 Second opening
29 Sleeve
30 Passage opening
D Axis of rotation
L1 Liquid phase
L2 Liquid phase
S Solid
P Product

1-9. (canceled)

10. A centrifugal separator configured to separate a flowable product to be processed in a centrifugal field into a solid phase, a first, lighter liquid phase, and a second, heavier liquid phase, the centrifugal separator comprising:
a rotatable centrifugal drum with a vertical axis of rotation and a separating chamber, wherein the separating chamber has a radially outer solids collecting chamber;
a separating disc pack arranged in the separating chamber of the rotatable centrifugal drum;
a distributor arranged in the rotatable centrifugal drum, wherein the distributor comprises distributor channels and is configured to feed the flowable product from a product feed pipe into the separating chamber, and configured so that, during operation of the centrifugal separator, the flowable product is fed into the separating chamber via the distributor, wherein the distributor comprises
first openings configured so that a first portion of the flowable product fed through the distributor is fed from the distributor channels into the separating disc pack; and
one or more second openings configured to introduce a second portion of the flowable product into the rotatable centrifugal drum in an outward direction;
discontinuously closable solids discharge openings configured to discharge the solid phase;
a first liquid discharge configured to discharge the first, lighter liquid phase; and
a second liquid discharge configured to discharge the second, heavier liquid phase.

11. The centrifugal separator of claim 10, wherein the first openings or the one of more second openings are formed in a distributor base of the distributor.

12. The centrifugal separator of claim 11, wherein replaceable sleeves are arranged on all or some of the first openings or the one or more second openings of the distributor base, wherein the replaceable sleeves have passage openings with a passage cross-section.

13. The centrifugal separator of claim 12, wherein the distributor base is divided into an upper part and a lower part in such a way that the replaceable sleeves are replaceable.

14. The centrifugal separator of claim 12, wherein the first portion of the flowable product fed by the distributor is fed from the distributor channels into rising channels of the separating disc pack.

15. The centrifugal separator of claim 10, wherein the second, heavier liquid phase is conveyed from the separating chamber to the second liquid discharge via a separating disc.

16. The centrifugal separator of claim 10, wherein a first portion of the second, heavier liquid phase discharged from the rotatable centrifugal drum is recirculated into the rotatable centrifugal drum and a second portion of the second, heavy liquid phase is dischargeable from an entirety of the centrifugal separator via a second line.

17. The centrifugal separator of claim 10, wherein the second, heavier liquid phase is a concentrate with an increased protein content compared to the flow product.

18. A method for sterilizing milk with a sterilization separator comprising a centrifugal drum with a vertical axis of rotation and a separating chamber having a radially outer solids collecting chamber, a separating disc pack arranged in the separating chamber of the centrifugal drum, and a distributor having distributor channels and arranged in the centrifugal drum, the method comprising:
i) providing the sterilization separator;
ii) accelerating the centrifugal drum to an operating speed;
iii) continuous centrifugal separation of milk fed into the centrifugal drum in the centrifugal drum, wherein the milk is separated into a solid phase, a first, lighter liquid phase, and a second, heavier liquid phase, wherein the second heavier liquid phase is formed from a flowable protein and germ concentrate; and
iv) recirculating a first part of the second, heavier liquid phase into the centrifugal drum and discharge a second part of the second, heavier liquid phase from the sterilization separator,
wherein, when the milk is fed into the sterilization separator, a first part of the milk to be processed is fed through first openings in the distributor into the separating disc pack and a second portion of the milk to be processed is fed through one or more second openings into a region radially outside the separating disc pack.
